(19) United States
(12) Patent Application Publication
(10) Pub. No.: US 2026/0291526 A1
(43) Pub. Date: Sep. 24, 2026

(54) DISTRIBUTED ANTENNA SYSTEM WITH RADIO FREQUENCY DONOR

(71) Applicant: Outdoor Wireless Networks LLC, Richardson, TX (US)

(72) Inventor: Michael Brobston, Richardson, TX (US)

(73) Assignee: Outdoor Wireless Networks LLC, Richardson, TX (US)

(21) Appl. No.: 19/472,357

(22) PCT Filed: Apr. 9, 2024
(86) PCT No.: PCT/US2024/023739

§ 371 Date: Oct. 3, 2025

Related U.S. Application Data
(60) Provisional application No. 63/495,636, filed on Apr. 12, 2023.

(51) Int. Cl. H04B 1/00

(52) U.S. Cl. CPC H04B 1/0057

(57) ABSTRACT

A RF donor for a DAS that includes a packetizer and a plurality of broadband samplers is provided. The packetizer is configured to packetize DL baseband signals of DL communication signals to a DAS distribution network and depacketize UL baseband signals of UL communication signals from the DAS distribution network. Each broadband sampler is configured to convert DL RF signals having select carrier frequencies of the DL communication signals to the DL baseband signals having select baseband frequencies and convert the UL baseband signals having select baseband frequencies of the UL communication signals to UL RF signals having select carrier frequencies. Each broadband sampler includes a RTC broadband DAC to process the UL communication signals to generate the carrier frequencies within a second Nyquist range. Each broadband sampler is in communication with each of a plurality of operator base station entities.

### CROSS-REFERENCE TO RELATED APPLICATIONS

This Application claims priority to U.S. Provisional Application Ser. No. 63/495,636, same title herewith, filed on Apr. 12, 2023, which is incorporated in its entirety herein by reference.

### BACKGROUND

A distributed antenna system (DAS) is commonly used to provide enhanced cellular phone coverage in indoor environments that frequently have insufficient coverage from outdoor cellular base stations due to increased signal attenuation caused by building structures. A DAS system is commonly comprised of multiple radio antennas that are distributed throughout the building. A base station downlink wireless signal may be captured and distributed by cables to the multiple radio antennas of the DAS which then retransmits the signal within the building. Likewise for the cellular uplink, the distributed radio antennas capture the uplink wireless signal from user equipment, such as mobile phones and these signals are amplified and routed by the cables back to the base station receiver equipment. In some implementations, the distribution is achieved between the radio antennas and the base station equipment using electrical signals on electrically conductive cables either as RF or digital signals. In other implementations the distribution is achieved between the radio antennas and the base station equipment using optical signals carried on optical fiber cables.

A common interface device used in a DAS system between the base station system and the digital signal distribution network is called a radio frequency (RF) donor circuit or RF donor card or RF donor. The RF donor performs the functions of capturing the RF downlink signals from a transmitter of an operator base station entity, such as a base station subsystem (BSS). The captured RF downlink signals are digitized and distributed to distributed radio antenna units. The RF donor also receives digitized uplink signals from the distributed radio antenna units. The received digital uplink signals are converted to RF signals and are provided to an operator base station entity receiver. By so doing, the DAS system broadly distributes the cellular signals from the operator base station entity to provide distributed wireless coverage within a building that would otherwise have insufficient coverage.

Within a cellular market area, there may be multiple network operators providing overlapping cellular coverage. In many cases, the operator base station entity of each operator within a market will operate in a different spectrum allocation, or band, from that of other operators within that market as a result of licensing of the spectrum by the FCC or other regulatory agency. Also in many cases, a specific operator may license to operate in multiple bands concurrently within a given market. Therefore, it is highly desirable that a DAS system have capability to support multiple bands of spectrum concurrently in order to support cellular service of a given operator in multiple bands and to simultaneously support the cellular service of multiple operators.

A RF donor contains similar functionality to radio equipment (except without the antenna) in that it captures an RF signal in the receiver, extracts the modulated information, and presents this at the digital interface. Conversely, a transmitter receives the digital baseband information and modulates this onto an RF carrier. It is common for operator base station entity radio equipment to be band specific since often compliance to the out-of-band emissions and susceptibility of various wireless standards requires the use of specific band filtering. In contrast, since a RF donor may be cabled to the base station entity equipment, in at least a BSS example, and is therefore neither transmitting nor receiving signals over the air via an antenna, it is not constrained in its instantaneous frequency coverage by these same air interface standards.

Since circuits of RF donors are frequently based on use of common radio architectures and tuner components, these circuits are often limited in their instantaneous bandwidth to a maximum range that is commonly 200 to 400 MHz. In a typical implementation of an RF Donor device connected to BSS equipment with multiple wireless operators, one tuner of the RF Donor is tuned to a first band in which the signals of a first operator operates and another tuner is tuned to a second band in which the signals of a second operator operates. Each carrier within an operator's band is processed through a sampler function to modulate, demodulate, and digitize the baseband data and to packetize and depacketize this data for distribution to and from the remote radio antennas connected to the DAS distribution network.

In this typical configuration, for the DAS system to concurrently cover multiple bands particularly in what is considered mid-band spectrum of 2400-4200 GHz, it is necessary to use multiple RF donor circuit channels tuned to specific sub-bands where the first operator may have its multiple carriers positioned in the first band and the second operator may have its multiple carriers positioned currently in the second band.

For example, the BSS of a first operator may transmit in a band that covers 3700 to 3980 MHz and the BSS of a second operator may transmit in a band that covers 2496 2690 MHz. The DAS system must support both bands concurrently.

Using a common RF tuner device having an instantaneous bandwidth of 400 MHz or less, one RF donor channel would be used for first operator signals and a second RF donor channel would be used for second operator signals. Given that many cellular base stations support 4T4R multiple input multiple output (MIMO), this multi-band condition would then require a total of eight RF donor channels in order to tune concurrently to the frequency bands of both operators and to process all carriers within each band for all four MIMO channels.

For the reasons stated above and for other reasons stated below which will become apparent to those skilled in the art upon reading and understanding the present specification, there is a need in the art for system to reduce the number of donor channels needed in a DAS system that services multiple operators.

### SUMMARY

The following summary is made by way of example and not by way of limitation. It is merely provided to aid the reader in understanding some of the aspects of the subject matter described. Embodiments implement a broadband receive (RX)/transmit (TX) channel in a RF donor of a DAS by using direct RF sampling and recombining downlink (DL) signals and split uplink (UL) signal between broadband samplers of the RF donor and the BSS equipment of multiple operators. The splitting and recombining, in an example, are done using a simple passive power/splitters.

In one embodiment, a DAS is provided. The DAS includes a RF donor, and at least one of a combiner/splitter, a switch and a duplexer for each broadband sampler. The RF donor is configured to interface DL communication signals and UL communication signals between a plurality of operator base station entities and a DAS distribution network. The RF donor includes a packetizer and a plurality of broadband samplers. The packetizer is configured to packetize DL baseband signals of the DL communication signals to the DAS distribution network and depacketize UL baseband signals of the UL communication signals from the DAS distribution network. The plurality of broadband samplers are in communication with the packetizer. Each broadband sampler is configured to convert DL RF signals, having select carrier frequencies of the DL communication signals, to the DL baseband signals having select baseband frequencies and convert the UL baseband signals having select baseband frequencies of the UL communication signals to UL RF signals having select carrier frequencies. Each broadband sampler includes a RTC DAC to processes the UL communication signals. The at least one of a combiner/splitter, switch and duplexer for each broadband sampler are configured to route the DL communication signals and UL communication signals to and from the plurality of operator base station entities and the RF donor.

In another embodiment, a RF donor for a DAS is provided. The RF donor includes a packetizer and a plurality of broadband samplers. The packetizer is configured to packetize DL baseband signals of DL communication signals to a DAS distribution network and depacketize UL baseband signals of UL communication signals from the DAS distribution network. The plurality of broadband samplers are in communication with the packetizer. Each broadband sampler is configured to convert DL RF signals having select carrier frequencies of the DL communication signals to the DL baseband signals having select baseband frequencies and convert the UL baseband signals having select baseband frequencies of the UL communication signals to UL RF signals having select carrier frequencies. Each broadband sampler includes a RTC broadband DAC to processes the UL communication signals to generate the carrier frequencies within a second Nyquist range. Each broadband sampler is in communication with each of a plurality of operator base station entities.

In yet another embodiment, a method of operating a DAS is provided. The method includes depacketizing UL baseband signals received from a DAS distribution system; upconverting the UL baseband signals to UL RF signals having carrier frequencies within a second Nyquist range; and communicating the UL baseband signal to a plurality of base station entities.

### BRIEF DESCRIPTION OF THE DRAWINGS

The present invention can be more easily understood and further advantages and uses thereof will be more readily apparent, when considered in view of the detailed description and the following figures in which:

FIG. 1A is a block diagram of a DAS according to an example aspect of the present application.

FIG. 1B is a block diagram of a portion of a DAS with a radio frequency donor system with reduced channel quantity according to an example aspect of the preset invention.

FIG. 2A is a block diagram of a broadband sampler according to an example aspect of the preset invention.

FIG. 2B is a block diagram of a switch in combination with a broadband sampler according to an example aspect of the preset invention.

FIG. 2C is a block diagram of a duplexer in combination with a broadband sampler according to an example aspect of the preset invention.

FIG. 3 is a block diagram of a DAS radio frequency donor system with a combiner/splitter and switch in combination with a broadband sampler according to an example aspect of the preset invention.

FIG. 4A is a block diagram of digital down converter with a dedicated numerically-controlled oscillator and a digital filter according to an example aspect of the preset invention.

FIG. 4B is a block diagram of a digital up converter with a dedicated numerically-controlled oscillator according to an example aspect of the preset invention.

FIG. 5 is a spectral plot illustrating a cycling structure in the frequency domain according to an example aspect of the preset invention.

FIG. 6A is a time domain response graph for a common non-return to zero digital-to-analog converter.

FIG. 6B is a frequency domain response graph for the common non-return to zero digital-to-analog converter.

FIG. 7A is a time domain response graph for a return-to-complement (RTC) DAC digital-to-analog converter.

FIG. 7B is a frequency domain response graph for the return-to-complement (RTC) DAC digital-to-analog converter.

FIG. 8 is a flow diagram of an example downlink communication method according to an example aspect of the preset invention.

FIG. 9 is a flow diagram of an example uplink communication method according to an example aspect of the preset invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a DAS with an RF donor that reduces channel quantity. Example embodiments implement a broadband RX/TX channel in a RF donor by using direct RF sampling and recombining DL signals and split UL signals between RF ports of a RF donor and the BSS equipment of multiple operators. The splitting and recombining, in an example, is done using simple passive power/splitters. The configuration reduces the number of channels required within the RF donor to process such a multi-carrier, multi-band, MIMO environment. Reducing the number of channels greatly reduces the size, cost, and power consumption of RF Donor circuits.

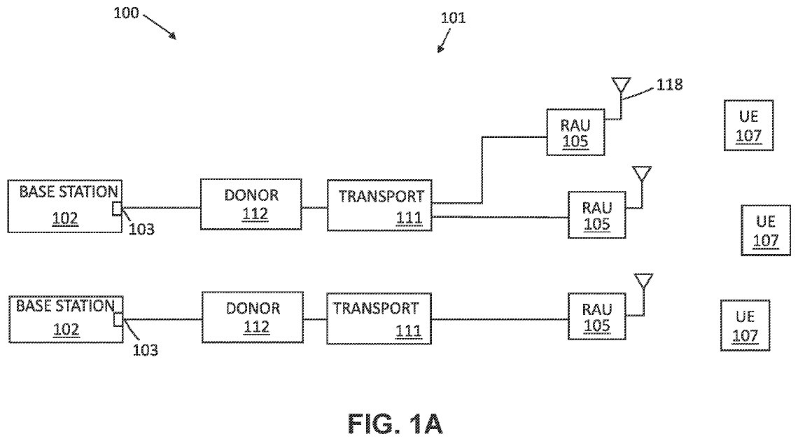

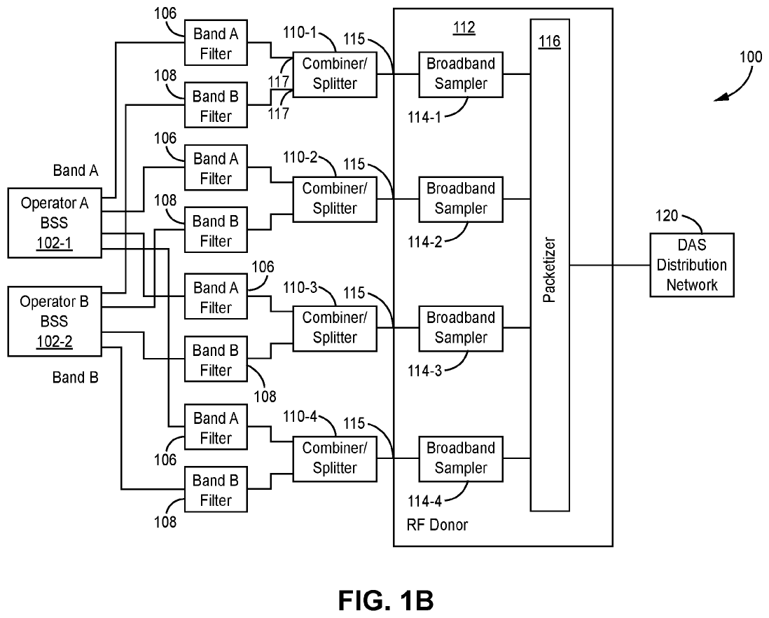

FIG. 1A is a block diagram of a simplified DAS 100 according to one example. The DAS 100 in this example includes a head end 101 and multiple remote antenna units (RAU) 105. The head end 101 comprises one or more donors 112 (which may be referred to donor cards or donor units) that are configured to communicatively couple operator base station entities 102 to the DAS 100. The head end 101 also comprises one or more transport cards or transport units 111 that are used to communicatively couple the donor units 112 to the remote antenna units 105 (either directly or indirectly) via one more intermediary units (not shown) and/or other RAUs 105).

One specific type of donor unit 112 is an RF donor 112 that is configured to couple the DAS 100 to an operator base station entity 102 using the external analog radio frequency (RF) port 103 (or interface) of each operator base station entity 102 (that may be a BSS in this example), that would otherwise be used to couple the operator base station entity 102 to one or more antennas (if the DAS 100 were not being used).

Each RF donor 112 is configured to receive downlink data from each operator base station entity 102 coupled to that RF donor 112 in the form of analog downlink RF signals and convert the received analog downlink RF signals to the digital fronthaul interface format natively used in the DAS 100 (for example, by digitizing, digitally down-converting, and filtering the received analog downlink RF signals) for transport via the DAS 100 (using one or more of the transport cards 111) to one or more RAU 105. Also, each RF donor 112 is configured to receive uplink data from the RAUs 105 (using one or more of the transport cards 111) in the digital fronthaul interface format natively used in the DAS 100 and, for each antenna port 103 of each operator base station 102 coupled that RF donor 112, summing or combining appropriate uplink data from various remote antenna units 105, converting the summed uplink data to an analog uplink RF signal (for example, by digitally up-converting and performing a digital-to-analog process), and communicating the analog uplink RF signal to that antenna port 103 of the operator base station 102.

Another specific type of donor unit 112 is a digital donor card or unit that is configured to communicatively couple the DAS 100 to donor or operator base station entities 102 (for example, baseband units (BBUs)) using a digital baseband fronthaul interface that would otherwise be used to couple each BBU to a remote radio head (RRH) (if the DAS 100 were not being used).

In one implementation, the digital baseband fronthaul interface comprises a time-domain baseband IQ fronthaul interface implemented in accordance with the Common Public Radio Interface (“CPRI”) specification. Other digital donor cards can be configured to use other digital baseband fronthaul interfaces. Each donor unit 112, which is a digital donor card in this example is configured to receive downlink data from each operator base station entity 102 which is a BBU in this example, is coupled to that donor unit 112 in the digital baseband fronthaul interface format used by that operator base station entity 102 and convert the received downlink data to the digital fronthaul interface format natively used in the DAS 100 (for example, by re-sampling, synchronizing, combining, separating, gain adjusting, etc.) for transport via the DAS 100 to one or more RAUs 105 (using one or more of the transport cards 111). Also, each digital donor card is configured to receive uplink data from the RAU 105 (using one or more of the transport cards 111) in the digital fronthaul interface format natively used in the DAS 100 and, for each antenna carrier of each donor BBU coupled to that digital donor card, summing or combining appropriate uplink data from various RAU 105, converting the summed uplink data to the digital baseband fronthaul interface format used by that BBU (for example, by re-sampling, synchronizing, combining, gain adjusting, etc.), and communicating the converted uplink data to that BBU.

Downlink data is transported via the DAS 100 to each RAU 105. The downlink data transmitted to each RAU 105 includes downlink data for each operator base station entity 102 served by that RAU 105. The RAU 105 receives the downlink data transmitted to it and uses the received downlink data to generate one or more analog downlink radio frequency signals for each operator base station entity 102 served by that access point (RAU 105) and radiates the one or more downlink radio frequency signals from one or more coverage antennas 118 associated with that RAU 105 for reception by user equipment (UE) 107 served by that operator base station entity 102.

Likewise, the RAU 105, for each operator base station entity 102 served by that RAU 105, receives one or more analog uplink radio frequency signals from UE 107 served by that operator base station entity 102. The one or more analog uplink RF signals are received via the one or more coverage antennas 118 associated with that RAU 105. For each served operator base station entity 102, the RAU 105 converts the associated received analog uplink RF signals to produce uplink data for that operator base station entity 102 in the digital fronthaul interface format natively used in the DAS 100 for transport via the DAS 100 to the appropriate donor card 112. Example embodiments implement a broadband RX/TX channel in a RF donor 112 using direct RF sampling and recombining of DL signals and split of UL signals between RF ports of a RF donor and the BSS equipment of multiple operators. The splitting and recombining, in an example, is done using simple passive power/splitters. As discussed above, the configuration reduces the number of channels required within the RF donor to process such a multi-carrier, multi-band, MIMO environment. Reducing the number of channels greatly reduces the size, cost, and power consumption of RF Donor circuits.

FIG. 1B is a block diagram of portion of DAS 100 having an RF donor 112 with reduced channel quantity of an example. The DAS 100 in this example includes a first operator base station entity 102-1 of a first operator, or operator A, that communicates within band A and a second operator base station entity 102-2 of a second operator, or operator B, that communicates within band B. In this example, the operator base station entities 102-1 and 102-2 are BSS. This example further includes a plurality of band A filters 106 and a plurality of band B filters 108. A pair of filters, that include one band A filter 106 and one band B filter, are located within an associated communication path between the first operator base station entity 102-1 and second operator base station entity 102-2 and an associated combiner/splitter that is generally references by 110. Filters 106 and 108 may be optional. For example, in cases where the base station entities 102-1 and 102-2 have internal filters, filters 106 and 108 may not be used. The combiner/splitter 110 in this example, includes a first combiner/splitter 110-1, a second combiner/splitter 110-2, third combiner/splitter 110-3, a fourth combiner/splitter 110-4. Each combiner/splitter 110 combines communication signals from the first and second operator base station entities 102-1 and 102-2 in a downlink (DL) direction and separates out communications directed to the respective first and second base station entities 102-1 and 102-2 in an uplink (UL) direction.

The RF donor 112 in this example includes a plurality of RF ports 115. Each combiner/splitter 110 is in communication with an associated RF port 115 of the RF donor 112. The RF donor 112 also includes broadband samplers that may generally be referenced by 114. Each broadband sampler 114 is in communication with associated RF ports 115. In the example of FIG. 1B, the broadband samplers 114 includes a first broadband sampler 114-1, a second broadband sampler 114-2, a third broadband sampler 114-3 and a fourth broadband sampler 114-4. Broadband sampler 114-1 is in communication with combiner/splitter 110-1, broadband sampler 114-2 is in communication with combiner/splitter 110-2, broadband sampler 114-3 is in communication with combiner/splitter 110-3 and broadband sampler 114-4 is in communication with combiner/splitter 110-4. The broadband samplers 114 are further in communication with a packetizer 116 of the RF donor 112. The packetizer 116 is in communication with a DAS distribution network 120. The packetizer packetizes and depacketizes digitized baseband data for distribution to and from remote radio antennas in the DAS distribution network 120. The DAS distribution network 120 may include the transport cards 111, RAUs and antennas 118 used to communicate with UEs 107 discussed above.

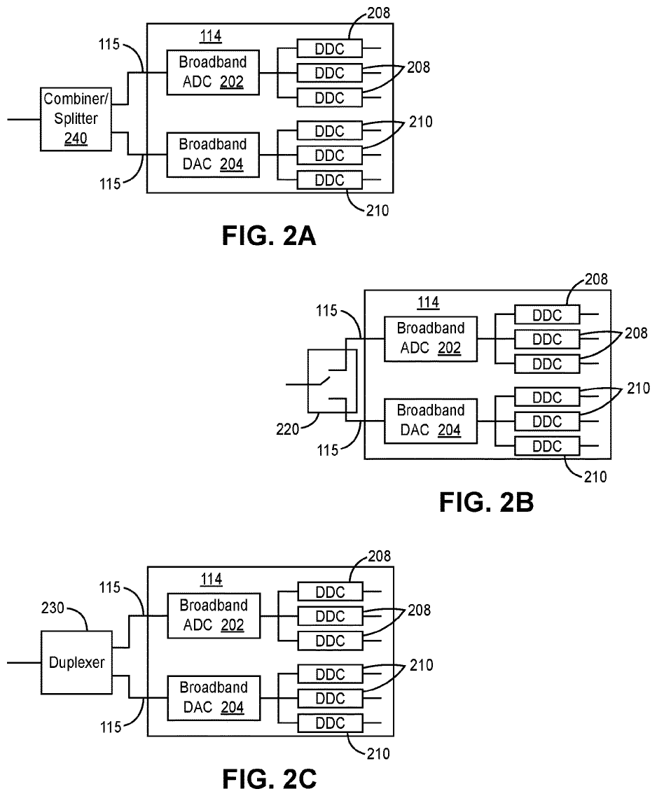

Each broadband sampler 114 includes a high-speed broadband analog-to-digital converter (ADC), a broadband digital-to-analog converter (DAC), a plurality of digital down converters (DDC) and plurality of digital up converters (DUC). One example of broadband sampler 114 is illustrated in FIG. 2A. The broadband sampler 114 in this example, includes a broadband ADC 202 and a plurality of DDC 208 used in a DL direction. In the UL direction, the broadband sampler 114 of the example of FIG. 2A includes a plurality of DUCs 210 that are in communication with broadband DAC 204.

Examples of other devices besides a combiner/splitter 240 that may be used the combine and separate out band A and band B communication signals to and from operator base station entities 102-1 and 102-2 are illustrated in FIG. 2B and FIG. 2C. In FIG. 2B, a switch 220 is used to combine and separate out the signals. The use of a switch 220 may be implemented in an application that uses timed UL and DL communication signals such as communication systems implementing a time division duplex (TDD) operation. In a TTD operation, signals operate at the same frequencies but are processed in alternating sequence. The switch 220 is this example would be timed to combine signals from band A and band B in the DL direction and separate out signals into the band A and band B in the UL direction. Another example of a device that can be used instead of a combiner/splitter is illustrated in FIG. 2C. The example of FIG. 2C illustrates the use of a duplexer 230. The duplexer 230 example may be used in a communication system that implements frequency division duplex (FDD) operations in which UL and DL signals may operate concurrently, but at separate frequencies.

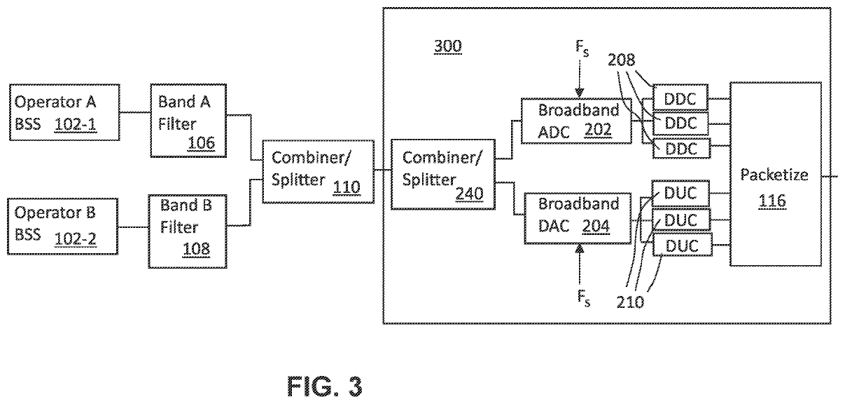

FIG. 3 further illustrates a block diagram of a DAS radio frequency donor system including an RF donor 300 in yet another example with reduced channel quantity that implements a second combiner/splitter 240 positioned in a series configuration with the first combiner/splitter 110 to support both FDD and TDD operations. In particular, the example of FIG. 3, relies on a passive power combiner/splitter 240 function that supports both FDD and TDD operation, yet relies on the combiner/splitter 240 to have sufficient isolation between ports connected to the ADC and DAC to allow FDD operation without interference between the UL and DL communication paths. Hence, many different combinations may be used.

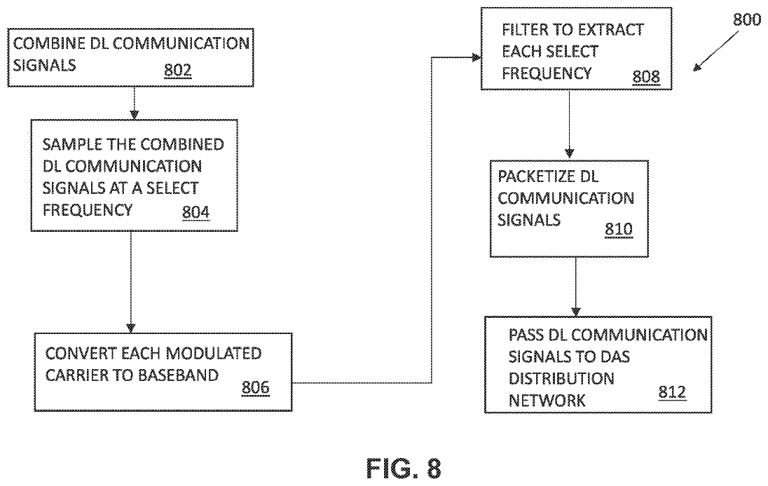

FIG. 8 illustrates a flow diagram of an example DL communication method 800 used to process DL communication signals from a plurality of base station entities using a DAS radio frequency donor system, such as the DAS 100 discussed above. DL communication method 800 is provided as a series of blocks. The sequence of the blocks may occur in a different order or in a parallel order in other examples. Hence, the invention is not limited to the sequence set out in FIG. 8.

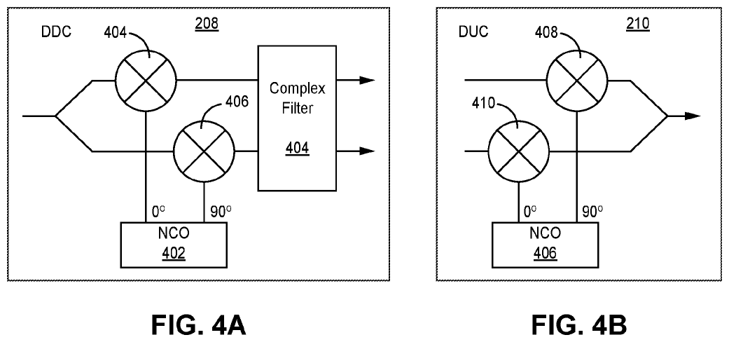

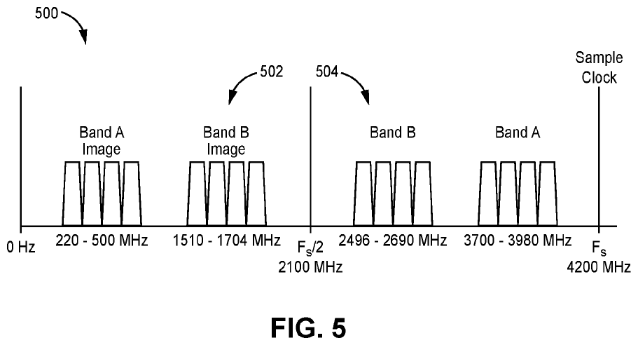

To capture the downlink signals from multiple bases stations, such as the two operator base station entities 102-1 and 102-2 discussed above, in a single RF Donor channel, the DL communication signals from operator A of operator base station entity 102-1, in an example range of 3700 to 3980 MHz, may be combined with the downlink communication signals from operator B operator base station entity 102-2 in an example range of 2496 to 2690 MHz using a passive combiner/splitter 110 at block 802. The DL communication signal are DL RF signals. Other types of combing/spitting systems may be used as discussed above. The combined spectrum from the common port of the passive combiner/splitter 110 is then sampled by a RF donor receiver using a high-speed ADC 202 at a select frequency at block 804. An example spectral plot 500 that illustrates the cycling structure in the frequency domain is illustrated in FIG. 5. In this example, an ADC sampling at 4200 MHz is capable of capturing the complete spectrum within a second Nyquist zone 504 and thereby create a first Nyquist image of this spectrum in a 220 MHz to 1704 MHz range 502 in its output samples as illustrated in the spectral plot 500 of FIG. 5. The DL RF signals from each operator base station entity 102-1 and 102-2 would contain multiple modulated carriers within its designated band. Each of the individual carriers within these two bands are converted individually to baseband in a DL direction by distributing the samples from the ADC 202 to a digital downconverter (DDC) 208 at block 806. Each DDC 208 in an example contains a dedicated DL numerically-controlled oscillator (NCO) 402, as illustrated in FIG. 4A that is tuned to a specific carrier frequency and is used to down convert the carrier frequency to a desired baseband frequency to generate DL baseband signals.

In particular, FIG. 4A illustrates an example architecture of DDC 208. In this example, DL DDC 208 accepts the sampled RF waveform and provides this waveform to the inputs of two multipliers 404 and 406. The sampled RF waveform is received from the ADC 202. NCO 402 generates two versions of a sampled tone waveform. The second version is at a 90° phase shift from the first. These sampled continuous wave (CW), unmodulated tones are used by the two multipliers 404 and 406 to down convert the sampled RF waveform that is provided to the multipliers 404 and 406 to produce signals at the multiplier outputs that are at the difference frequency. The output signals from the multipliers 404 and 406 are positioned at the frequency of the sampled RF signals minus the sampled NCO tones (f_{RF}−f_{NCO}) and at the frequency of the sampled NCO tones minus the sampled RF signals (f_{NCO}−f_{RF}). Since the NCO tones provided to the multipliers 404 and 406 are at 90° offset or in other words “in quadrature,” the two multipliers 404 and 406 produce down converted waveforms that are also in quadrature. These are generally referenced at the I and Q versions of the down converted waveform. Taken in quadrature, this allows subsequent signal processing blocks to discriminate and select either the +f_{IF} component (f_{RF}−f_{NCO}) or the −f_{IF} component (f_{NCO}−f_{RF}) for processing.

In the case of direct down conversion to baseband that would be used for a RF Donor implementation, f_{NCO}=f_{RF}. In this case, the I and Q outputs of the multipliers contain the complex modulated waveform at baseband. Following the multipliers, the I and Q components would be sent to a complex baseband digital filter 404 that would then be used to attenuate any unwanted images and may also be used to decimate the complex I and Q components of the waveform. This digital filter 404 may be comprised of various filter architectures such as finite impulse response (FIR), half-band filter (HBF), cascaded integrator comb (CIC), infinite impulse response (IIR), or any combination of these types of digital filter structures.

The individual digital sample streams (DL baseband signals) are then passed to the packetizer 116 which prepares (packetizes the DL signals at block 810) and passes the DL baseband signals of the DL communication signals to the DAS distribution network 120 at block 812 where the DL communication signals are communicated to user equipment (UE).

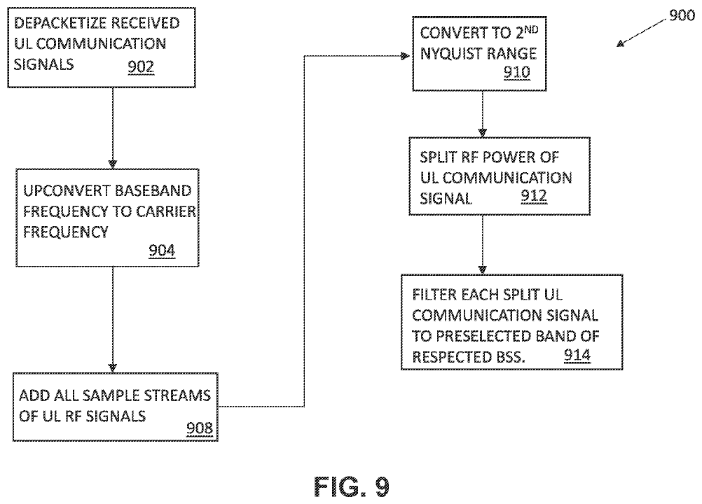

In similar manner, UL communication signals from UEs detected by distributed radio antennas of the DAS distribution network 120. The UL communication signals from the UEs are modulated and upconverted onto a carrier at the appropriate frequency using DUCs 210 to convert UL baseband signals to UL RF signals. FIG. 9 illustrates a flow diagram of an example UL communication method 900 used to process UL communication signals from UEs via a DAS distribution network 120 with a DAS radio frequency donor system, such as the DAS 100 discussed above. UL method 900 is provided as a series of blocks. The sequence of the blocks may occur in a different order or in a parallel order in other examples. Hence, the invention is not limited to the sequence set out in FIG. 9.

UL communication signals from UEs are received by the packetizer 116 of the RF donor 112 via the DAS distribution network 120. The UL communication signals are depacketized at block 902. Each DUC 210 of an associated broad band sampler 114 contains a dedicated UL NCO 406, as illustrated in FIG. 4B, that would be tuned to the specific baseband frequency to upconvert the baseband frequency of the UL baseband signals of the UL communication signals to the carrier frequency at block 904.

In particular, FIG. 4B illustrates an example architecture of DUC 210. In this example, the DUC 210 accepts sampled quadrature intermediate frequency (IF) waveforms and provides this waveform to the inputs of two multipliers 408 and 410. NCO 406 generates two versions of a sampled tone waveform. The second version is at a 90° phase shift from the first. These sampled CW, unmodulated tones, are used by the two multipliers 408 and 410 to upconvert the sampled quadrature IF waveforms that are provided to the multipliers 408 and 410 to produce signals at the multiplier outputs that are at the sum frequency. The output signals from the multipliers 408 and 410 are positioned at the frequency of the sampled quadrature IF signals plus and minus the sampled NCO tones (f_{NCO}−f_{IF}) and (f_{NCO}+f_{IF}). The signals from the two multipliers 408 and 410 are combined or added to produce a single sampled RF waveform at one of the two frequencies, either f_{NCO}−f_{IF} or f_{NCO}+f_{IF}. This selection is controlled by selecting which of the I or Q components of the quadrature sampled IF waveforms are multiplied with which of the two quadrature tones from the NCO 406. The sampled RF waveform is generally what may then be provided to DAC 204.

The communication signals are converted to carrier frequencies within the first Nyquist frequency range of the high-speed DAC 204. In this example, the high-speed DAC 204 would also be sampled at 4200 MHz. Therefore, operator A carriers would be set within a first Nyquist frequency range of 220-500 MHz and the operator B carriers would be set within a first Nyquist frequency range of 1520-1704 MHz. The sample streams from all of the DUCs 210 would be added digitally and provided as input to the DAC 204 at block 908 in an example. When sampled at 4200 MHz by the DAC 204, the carrier frequencies would then be converted to the second Nyquist zone 504 at the appropriate RF frequencies within the range of 2496-3980 MHz at the DAC 204 output at block 910.

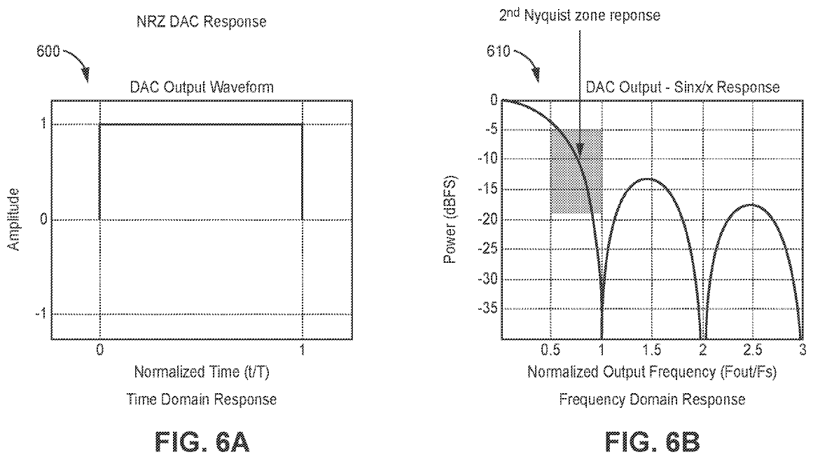

Two types of DAC 204 could be used, a common non-return to zero (NRZ) DAC and a return-to-complement (RTC) DAC. Some example embodiments use RTC DACs because a zero-order hold behavior of a common NRZ DAC might not provide the desired response in the second Nyquist zone. The output of the NRZ DAC holds an output voltage or current corresponding to the last sample constant through the sample period as shown in the NRZ DAC response graph 600 of FIG. 6A. As a result, the frequency response of a NRZ DAC within the second Nyquist zone has a very steep slope, as illustrated in the second Nyquist zone response graph 610 of FIG. 6B. The slope of the within the second Nyquist zone reaches a null as the frequency approaches the sampling frequency. Hence, this zone makes it difficult for conversion of a broadband signal within its second Nyquist frequency range.

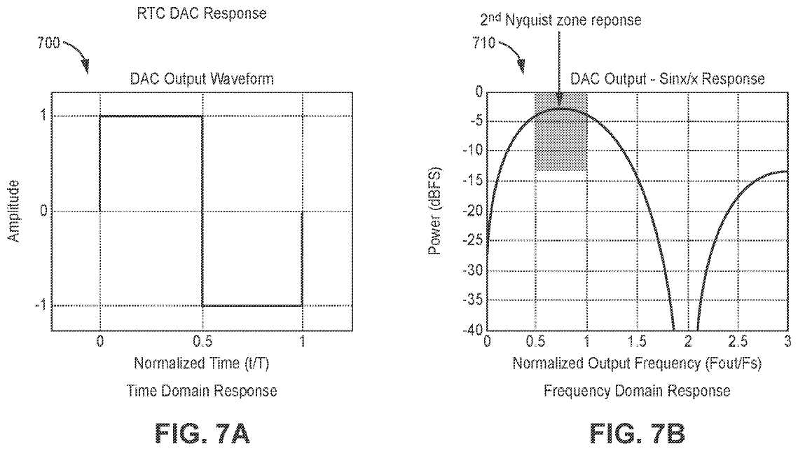

An output of a RTC DAC alternates between this output voltage or current level for the first half of the sample period and its negative complement for the second half of the sample period as illustrated in the RTC DAC response graph 700 of FIG. 7A. As a result, the RTC DAC is provided with relatively strong and constant response throughout its second Nyquist zone as illustrated in the second Nyquist zone graph 710 of FIG. 7B. The remaining variation in response across this second Nyquist zone is predictable and within reasonable limits and can therefore be equalized digitally prior to the DAC 204 to provide a composite flat response through much of the second Nyquist zone. Use of an RTC DAC, in some examples, allow for relatively high frequency signals to be produced from the DAC 204 within the second Nyquist zone using a sample clock operating at half the frequency that would be needed by an NRZ DAC. The sampling example illustrated in FIG. 5 is based on the use of an RTC DAC.

The DAC output of the uplink carriers within the frequency range of 2496-3980 MHz, the UL RF signals, are then routed from the RF donor 112 to a splitting device such as a combiner/splitter 110 in an example. The combiner/splitter 110 splits the RF power in the UL RF signals between two ports 117 at block 912. Each port 117 is filtered using an RF filter, such as filters 106 and 108, to select the band for operators A and B. The filter UL carrier signals are then communicated to the respective operator base station entity 102-1 and 102-2 in block 914.

While this example designates two specific licensed frequency bands and ADC/DAC sample rates, this same technique is applicable to other band combinations, number of bands, and different ADC/DAC sample rates. Examples provide technique of using a broadband RFD channel in combination with passive pre-combining to reduce the number of RFD channels needed to support multi-band use cases in a DAS system.

### EXAMPLE EMBODIMENTS

Example 1 includes a DAS. The DAS includes a RF donor, and at least one of a combiner/splitter, a switch and a duplexer for each broadband sampler. The RF donor is configured to interface DL communication signals and UL communication signals between a plurality of operator base station entities and a DAS distribution network. The RF donor includes a packetizer and a plurality of broadband samplers. The packetizer is configured to packetize DL baseband signals of the DL communication signals to the DAS distribution network and depacketize UL baseband signals of the UL communication signals from the DAS distribution network. The plurality of broadband samplers are in communication with the packetizer. Each broadband sampler is configured to convert DL RF signals, having select carrier frequencies of the DL communication signals, to the DL baseband signals having select baseband frequencies and convert the UL baseband signals having select baseband frequencies of the UL communication signals to UL RF signals having select carrier frequencies. Each broadband sampler includes a RTC DAC to processes the UL communication signals. The at least one of a combiner/splitter, switch and duplexer for each broadband sampler are configured to route the DL communication signals and UL communication signals to and from the plurality of operator base station entities and the RF donor.
Example 2 includes the DAS of Example 1, wherein the at least one of the combiner/splitter, the switch and the duplexer is a combiner/splitter. The DAS further includes the combiner/splitter that is configured to combine the DL communication signals from the plurality of operator base station entities and split the UL communication signals into frequency bands used by the plurality of operator BSSs. A band filter is located in each communication path between each operator base station entity and an associated combiner/splitter. Each band filter is configured to designate a frequency band associated with an associated operator base station entity.
Example 3 includes the DAS of Example 1, wherein the at least one of the combiner/splitter, the switch and the duplexer includes at least a first combiner/splitter positioned in series with a second combiner switch to support both frequency division duplex (FDD) and time frequency division duplex TDD operations.
Example 4 includes the DAS of any of the Examples 1-3, wherein each broadband sampler includes a broadband ADC, a plurality of DDCs, a DAC and a plurality of DUCs. The broadband ADC is in communication with the at least one of the combiner/splitter, the switch and the duplexer. Each DDC is configured to down convert an output frequency of the ADC to a specific baseband frequency for the DL communication signals communicated to the packetizer. The broadband DAC is in communication with the at least one of the combiner/splitter, the switch and the duplexer. Each DUC is configured to up convert an associated baseband frequency in the UL communication signals from the packetizer and output specific carrier frequencies in the UL communication signals to an input of the broadband DAC.
Example 5 includes the DAS of Example 4, wherein each DDC further includes a DL NCO that is tuned to the associated carrier frequency. The DL NCO is configured to down convert the associated carrier frequency to the specific baseband frequency.
Example 6 includes the DAS of Example 5, further including a digital filter in communication with each NCO. Each digital filter configured to filter out frequencies other than a baseband frequency associated with a channel associated with a communication path for the DL communication signals.
Example 7 includes the DAS of any of the Examples 4-6, wherein each DUC further includes a UL NCO tuned to the associated baseband frequency. The UL NCO is configured to up convert the associated baseband frequency to the specific carrier frequency.
Example 8 includes a RF donor for a DAS, the RF donor including a packetizer and a plurality of broadband samplers. The packetizer is configured to packetize DL baseband signals of DL communication signals to a DAS distribution network and depacketize UL baseband signals of UL communication signals from the DAS distribution network. The plurality of broadband samplers are in communication with the packetizer. Each broadband sampler is configured to convert DL RF signals having select carrier frequencies of the DL communication signals to the DL baseband signals having select baseband frequencies and convert the UL baseband signals having select baseband frequencies of the UL communication signals to UL RF signals having select carrier frequencies. Each broadband sampler includes a RTC broadband DAC to processes the UL communication signals to generate the carrier frequencies within a second Nyquist range. Each broadband sampler is in communication with each of a plurality of operator BSSs.
Example 9 includes the RF donor of Example 8, wherein each broadband sampler includes a broadband ADC, a plurality of DDCs, a broadband DAC and a plurality of DUCs. The ADC is in communication with the at least one of a combiner/splitter, a switch and a duplexer. Each DDC is configured to down convert an associated carrier frequency to a specific baseband frequency in the DL communication signals between the broadband ADC and the packetizer. The broadband DAC is in communication with the at least one of the combiner/splitter, the switch and the duplexer. Each DUC is configured to up convert an associated baseband frequency to a specific carrier frequency in the UL communication signals between the packetizer and the broadband DAC.
Example 10 includes the RF donor of Example 9, wherein each DDC further includes a DL NCO tuned to the associated carrier frequency. The DL NCO is configured to down convert the associated carrier frequency to the specific baseband frequency.
Example 11 includes the RF donor of Example 10, further including a digital filter in communication with each NCO. Each digital filter configured to filter out frequencies other than a desired channel frequency associated with an associated DL path of the baseband frequency.
Example 12 includes the RF donor of any of the Examples 9-11, wherein each DUC further includes a UL NCO tuned to the associated baseband frequency. The UL NCO is configured to up convert the associated baseband frequency to the specific carrier frequency.
Example 13 includes a method of operating a DAS. The method includes depacketizing UL baseband signals received from a DAS distribution system; upconverting the UL baseband signals to UL RF signals having carrier frequencies within a second Nyquist range; and communicating the UL baseband signal to a plurality of base station entities.
Example 14 includes the method of Example 13, further including filtering the UL RF signals to a select frequency band associated with an operator base station entity of the plurality of operator base station entities.
Example 15 includes the method of Example 14, further including splitting RF power of the UL RF signals to communicate the UL RF signals to associated filters that filter the UL RF signals to the select frequency band associated with the base station entities of the plurality of operator base station entities.
Example 16 includes the method of any of the Examples 13-15, wherein the upconverting of the UL baseband signals to the UL radio frequency (RF) signals having carrier frequencies within a second Nyquist range is accomplished with a plurality of DUCs in communication with a broadband DAC.
Example 17 includes the method of Example 16, further including adding sample streams from outputs of the DUCs that are in communication with the broadband DAC.
Example 18 includes the method of any of the Examples 13-17, further including combining DL RF signals from the plurality of operator base station entities; down converting the DL RF signals to DL baseband signals; packetizing the DL baseband signals; and communicating DL baseband signals to the DAS distribution system.
Example 19 includes the method of Example 18, wherein down converting the DL RF signals to DL baseband signals further includes sampling the combined DL RF signals with an ADC; and distributing the samples from the ADC to a plurality of DDCs.
Example 20 includes the method of any of Example 19, further including filtering outputs of the plurality of DDCs to set DL streams at select baseband frequencies.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A distributed antenna system (DAS) comprising:
a radio frequency (RF) donor configured to interface downlink (DL) communication signals and uplink (UL) communication signals between a plurality of operator base station entities and a DAS distribution network, the RF donor including,
a packetizer configured to packetize DL baseband signals of the DL communication signals to the DAS distribution network and depacketize UL baseband signals of the UL communication signals from the DAS distribution network, and
a plurality of broadband samplers in communication with the packetizer, each broadband sampler configured to convert DL radio frequency (RF) signals having select carrier frequencies of the DL communication signals to the DL baseband signals having select baseband frequencies and convert the UL baseband signals having select baseband frequencies of the UL communication signals to UL RF signals having select carrier frequencies, each broadband sampler including a return-to-complement (RTC) broadband digital-to-analog converter (DAC) to processes the UL communication signals; and
at least one of a combiner/splitter, a switch and a duplexer for each broadband sampler configured to route the DL communication signals and UL communication signals to and from the plurality of operator base station entities and the RF donor.

2. The DAS of claim 1, wherein the at least one of the combiner/splitter, the switch and the duplexer is a combiner/splitter, the combiner/splitter configured to combine the DL communication signals from the plurality of operator base station entities and split the UL communication signals into frequency bands used by the plurality of operator base station entities, the DAS further comprising:
a band filter in each communication path between each operator base station entity and an associated combiner/splitter, each band filter configured to designate a frequency band associated with an associated operator base station entity.

3. The DAS of claim 1, wherein the at least one of the combiner/splitter, the switch and the duplexer includes at least a first combiner/splitter positioned in series with a second combiner switch to support both frequency division duplex (FDD) and time frequency division duplex TDD operations.

4. The DAS of claims 1, wherein each broadband sampler comprises:
a broadband analog-to-digital converter (ADC) in communication with the at least one of the combiner/splitter, the switch and the duplexer;
a plurality of digital down converters (DDCs), each DDC configured to down convert an output frequency of the ADC to a specific baseband frequency for the DL communication signals communicated to the packetizer;
a broadband digital-to-analog converter (DAC) in communication with the at least one of the combiner/splitter, the switch and the duplexer; and
a plurality of digital up converters (DUCs), each DUC configured to up convert an associated baseband frequency in the UL communication signals from the packetizer and output specific carrier frequencies in the UL communication signals to an input of the broadband DAC.

5. The DAS of claim 4, wherein each DDC further comprises:
a DL numerically-controlled oscillator (NCO) that is tuned to the associated carrier frequency, the DL NCO configured to down convert the associated carrier frequency to the specific baseband frequency.

6. The DAS of claim 5, further comprising
a digital filter in communication with each NCO, each digital filter configured to filter out frequencies other than a baseband frequency associated with a channel associated with a communication path for the DL communication signals.

7. The DAS of claims 4, wherein each DUC further comprises:
a UL NCO tuned to the associated baseband frequency, the UL NCO is configured to up convert the associated baseband frequency to the specific carrier frequency.

8. A radio frequency (RF) donor for a distributed antenna system (DAS), the RF donor comprising:
a packetizer configured to packetize downlink (DL) baseband signals of DL communication signals to a DAS distribution network and depacketize uplink (UL) baseband signals of UL communication signals from the DAS distribution network; and
a plurality of broadband samplers in communication with the packetizer, each broadband sampler configured to convert DL radio frequency (RF) signals having select carrier frequencies of the DL communication signals to the DL baseband signals having select baseband frequencies and convert the UL baseband signals having select baseband frequencies of the UL communication signals to UL RF signals having select carrier frequencies, each broadband sampler including a return-to-complement (RTC) broadband digital-to-analog converter (DAC) to processes the UL communication signals to generate the carrier frequencies within a second Nyquist range, each broadband sampler in communication with each of a plurality of operator base station entities.

9. The RF donor of claim 8, wherein each broadband sampler comprises:
a broadband analog-to-digital converter (ADC) in communication with at least one of a combiner/splitter, a switch and a duplexer;
a plurality of digital down converters (DDCs), each DDC configured to down convert an associated carrier frequency to a specific baseband frequency in the DL communication signals between the broadband ADC and the packetizer;
a broadband digital-to-analog converter (DAC) in communication with the at least one of the combiner/splitter, the switch and the duplexer; and
a plurality of digital up converters (DUCs), each DUC configured to up convert an associated baseband frequency to a specific carrier frequency in the UL communication signals between the packetizer and the broadband DAC.

10. The RF donor of claim 9, wherein each DDC further comprises:
a DL numerically-controlled oscillator (NCO) tuned to the associated carrier frequency, the DL NCO configured to down convert the associated carrier frequency to the specific baseband frequency.

11. The RF donor of claim 10, further comprising
a digital filter in communication with each NCO, each digital filter configured to filter out frequencies other than a desired channel frequency associated with an associated DL path of the baseband frequency.

12. The RF donor of claim 9, wherein each DUC further comprises:
a UL NCO tuned to the associated baseband frequency, the UL NCO configured up convert the associated baseband frequency to the specific carrier frequency.

13. A method of operating a distributed antenna system (DAS), the method comprising:
depacketizing uplink (UL) baseband signals received from a DAS distribution system; and
upconverting the UL baseband signals to UL radio frequency (RF) signals having carrier frequencies within a second Nyquist range; and
communicating the UL baseband signal to a plurality of operator base station entities.

14. The method of claim 13, further comprising:
filtering the UL RF signals to a select frequency band associated with an operator base station entity of the plurality of operator base station entities.

15. The method of claim 14, further comprising:
splitting radio frequency (RF) power of the UL RF signals to communicate the UL RF signals to associated filters that filter the UL RF signals to the select frequency band associated with the operator base station entity of the plurality of operator base station entities.

16. The method of claim 13, wherein the upconverting of the UL baseband signals to the UL radio frequency (RF) signals having carrier frequencies within a second Nyquist range is accomplished with a plurality of digital up converters (DUCs) in communication with a broadband digital-to-analog converter (DAC).

17. The method of claim 16, further comprising
adding sample streams from outputs of the DUCs that are in communication with the broadband DAC.

18. The method of claim 13, further comprising:
combining downlink (DL) RF signals from the plurality of operator base station entities;
down converting the DL RF signals to DL baseband signals;
packetizing the DL baseband signals; and
communicating DL baseband signals to the DAS distribution system.

19. The method of claim 18, wherein down converting the DL RF signals to DL baseband signals further comprises:
sampling the combined DL RF signals with an analog-to-digital converter (ADC); and
distributing the samples from the ADC to a plurality of digital down converters (DDCs).

20. The method of claim 19, further comprising:
filtering outputs of the plurality of DDCs to set DL streams at select baseband frequencies.
